(19) United States
(12) Patent Application Publication
(10) Pub. No.: US 2004/0199442 A1
(43) Pub. Date: Oct. 7, 2004

(54) Method and system for offering and selling a multi-purpose currency option

(76) Inventor: Rainer Haberle, Giffers (CH)

Correspondence Address: PROSKAUER ROSE LLP, PATENT DEPARTMENT, 1585 BROADWAY, NEW YORK, NY, 10036-8299, US

(21) Appl. No.: 10/406,885

(22) Filed: Apr. 4, 2003

(51) Int. Cl. G06F 17/60

(52) U.S. Cl. 705/35

(57) ABSTRACT

A method and system for offering and selling an inventive currency option that is a marketable security and is structured as a call on a first asset in a first currency and a put on a second asset in a second currency. The first asset can be cash or a cash investment. The second asset can be any marketable financial instrument. The currency option has an option price, an issue date, an expiration date, and a low exercise price. The issuer of the option determines the option price and sells the currency option to a purchaser who purchases the currency option for investment purposes.

### FIELD OF THE INVENTION

The present invention relates to a method and system for offering and selling currency options. More specifically, the present invention relates to a method and system for offering and selling a particular inventive currency option for investment purposes that can be used for speculative currency trading, currency risk management or risk hedging, or as an alternative to a cash investment. The inventive currency option produces returns that are capital gains as opposed to interest income. It can be traded over electronic banking systems, inter-bank markets, the internet, exchanges, over-the-counter, or other communication channels; it combines advantageous characteristics of foreign exchange products (such as currency options and foreign exchange forward transactions) and cash investments with the trading and distribution capabilities of a marketable security; and it does not expose the option writer to counterparty risk or require credit margins or credit lines.

### BACKGROUND OF THE INVENTION

There are a number of different categories of assets available to investors, such as stocks, bonds, commodities, and cash. Money market instruments are another type of asset. Money market instruments include short-term debt instruments, such as commercial paper, money market funds, Treasury bills, and floating rate notes. Money market instruments are also known as cash investments.

Different assets expose investors to different potential risks and provide investors with different potential returns. For example, stocks generally provide investors with the potential for higher returns than cash investments, but stocks also generally expose investors to greater potential risks than cash investments. Because different assets have different potential risks and different potential returns, investors often seek to diversify their investments among a number of different assets to minimize risk and maximize return.

In making investment decisions, investors also often consider the form in which the returns on their investments take place. For either legal or religious reasons, investors often have a preference for investment returns that take the form of capital gains as opposed to interest income. Thus, if the potential risks and potential returns from investing in two assets are comparable, investors may prefer to invest in the asset that produces appreciation in the form of a capital gain instead of interest income.

Another type of asset is an option. Options are also referred to as derivatives because they derive their value from the worth of an underlying asset. Generally, an option gives the buyer the right, but not the obligation, to buy or sell an underlying asset at a set price on or before a given date. An option can take the form of a security, just like a stock or bond, and it constitutes a binding contract with defined terms and properties. The underlying asset is the asset that must be delivered if the option is exercised. There are some options, however, that are settled in cash upon exercise.

The parties to an option transaction are the buyer or purchaser of an option and the seller of an option. The buyer or purchaser is also referred to as the option holder. The seller of an option also can be referred to as the writer, grantor, or issuer of the option.

Two types of options are calls and puts. A call gives its holder the right (but not the obligation) to purchase an underlying asset at a certain price within a specific period of time or at expiration. A put option is the opposite of a call option. A put gives its holder the right (but not the obligation) to sell an underlying asset at a certain price within a specific period of time or at expiration.

Call options usually increase in value as the value of the underlying asset increases. Put options usually increase in value as the value of the underlying asset decreases. The option price that a buyer pays for an option generally includes an option premium to secure the right to buy or sell the underlying asset at a certain price called the exercise price or strike price.

The expiration date is the date on which an option is no longer valid and ceases to exist. For an American-style option, the expiration date is the last day on which an option can be exercised. For a European-style option, the expiration date is the only date on which the option can be exercised.

Investors can purchase options to buy or sell a wide variety of underlying assets. One type of option is a currency option. A currency option is the right (but not the obligation) to buy (in the case of a call) or sell (in the case of a put) a set amount of one currency for another at a predetermined price at a predetermined time in the future.

One reason investors purchase currency options is to manage foreign exchange rise exposure. Foreign exchange risk exposure can arise from many different activities. For example, a traveler going to visit a foreign country has the risk that if that country's currency appreciates against the traveler's own currency, then the traveler's trip will be more expensive. An exporter who sells its product in foreign currency has the risk that if the value of that foreign currency falls, then the revenues in the exporter's home currency will be lower. An importer who buys goods priced in foreign currency has the risk that the foreign currency will appreciate and make the local currency cost greater than expected. Fund managers and companies who own foreign assets also are exposed to changes in the exchange rates of currencies.

Foreign exchange rates can be volatile. The volatility of foreign exchange rates creates investment risks, as well as opportunities for speculative gain when rate changes can be accurately predicted. Thus, investors also invest in currency options to attempt to profit from accurate predictions on changes in currency exchange rates.

In every foreign exchange transaction, one currency is purchased and another currency is sold. Consequently, every currency option is both a call and a put. For example, an option to buy Euros against United States Dollars is both a Euro call and a United States Dollar put. Conversely, an option to sell Euros against United States Dollars is a Euro put and United States Dollar call.

The currencies that are purchased and sold in a foreign exchange transaction are also referred to as a currency pair. A currency pair consists of a base currency and a counter currency. EUR/USD is an example of a currency pair. The base currency is EUR (Euros) and its value remains constant at one Euro. The counter currency is USD (United States Dollars). The base currency is also referred to as the first currency. The value of the counter currency will fluctuate up and down. The counter currency is also referred to as the second currency in a currency pair. If the EUR/USD currency pair is quoted at 0.9000, it means that one Euro will cost USD 0.90. If the EUR/USD goes to 0.9200, the same Euro is now equivalent to USD 0.92.

Foreign exchange transactions are offered as spot transactions or forward transactions. Spot transactions are exchanges of one currency for another for immediate delivery. Spot transactions are conducted at an exchange rate for immediate delivery known as the spot rate. Forward foreign exchange transactions are exchanges of one currency for another at a future date. Forward transactions are conducted at a forward rate, which is the exchange rate available at the time of the purchase of the forward exchange transaction for exchanging currency at some specified date in the future.

The two parties to a currency option transaction are the option buyer or purchaser and the option seller. The option seller also can be referred to as the grantor, writer, or issuer. The option buyer may, for an agreed upon price called the option price, purchase from the option writer a commitment that the option seller will sell (or purchase) a specified amount of an underlying currency upon demand. The option extends only until the expiration date. The rate at which one currency can be purchased or sold is one of the terms of the option and is called the exercise price. The exercise price is also referred to as the strike price.

A currency option can be described by referring to the currency pair, the expiration date, the option price, the exercise price, which currency is to be bought, and which currency is to be sold. Currency option expirations can also be American-style or European-style. American-style currency options can be exercised on any business day prior to the expiration date. European-style currency options can be exercised at the date of expiration only.

Currency options can be quoted in one of two ways: American-terms, in which a currency is quoted in terms of the United States Dollar per unit of foreign currency, and in European-terms, in which the United States Dollar is quoted in terms of units of foreign currency per dollar. The same logic can be applied to currency pairs in which the United States Dollar is not one of the currencies. Either currency can be expressed in terms of the other.

There are a variety of option pricing models that are well-known in the art, such as the Black-Scholes model. Option pricing models are also discussed in detail in texts, such as John C. Hull, Options, Futures, and Other Derivative Securities. In the final analysis, option prices must be low enough to induce potential buyers to buy and high enough to induce potential option writers to sell.

A call option is out-of-the-money if the exercise price is greater than the market price of the underlying asset. When a call option is out-of-the-money, the option holder has the right to purchase the underlying asset at a price higher than the market price, which is valuable only if the option has not yet expired. A put option is out-of-the-money if the exercise price is lower than the market price of the underlying asset. A put option that has an exercise price higher than the underlying asset's market price, or a call option with an exercise price lower than the underlying asset's market price is in-the-money.

A call option with an exercise price substantially below the underlying asset's market price is a deep-in-the-money option. A call option with an exercise price substantially above the market price is a deep-out-of-the-money option. A put option with an exercise price substantially above the underlying asset's market price is deep-in-the-money. And a put option with an exercise price substantially below the underlying asset's market price is deep-out-of-the-money.

A warrant is another type of asset that is also an option. Warrants are a form of derivative because they derive their value from an underlying asset, such as common stock, commodities, or currencies. For example, some warrants give holders the right to buy or sell stocks for a specified price at or by a particular date in the future. Other warrants entitle holders to buy or sell a currency at or by a particular date in the future. Banks, corporations, and other financial institutions issue warrants. Warrants are options that take the form of a security.

Warrants can be call warrants or put warrants. Call warrants give the warrant holder the right to buy the underlying asset from the warrant issuer at a particular price, on or before a particular exercise date. Put warrants give the warrant holder the right to sell the underlying asset to the warrant issuer at a particular exercise price, on or before a particular exercise date. Warrants can also be European-style (exercisable only on the expiration date) or American-style (exercisable at any time on or before the expiration date). The underlying asset for a warrant can be any asset, such as stocks, currencies, or commodities. Warrants also have a conversion ratio, which is the amount of the underlying asset that a warrant holder would buy or sell of the underlying asset upon exercising the warrant per unit of the warrant.

For currency warrants or foreign exchange warrants, the underlying asset is an exchange of one currency for another currency. One currency is purchased and another currency is sold. Consequently, like currency options, every currency warrant is both a call and a put.

Another type of option is a low exercise price option (“LEPO”). The Swiss Options Exchange offered LEPOs beginning in the early 1990s, and the Australian Stock Exchange introduced LEPOs in 1995.

The purchaser or holder of a LEPO has the right, but not the obligation, to buy an agreed number of shares of a common stock at a specified future date in return for the payment of a premium and an exercise price. The Australian Stock Exchange also offers Index LEPOs where the underlying asset is shares in an index based on the prices of the stocks of major listed companies according to market capitalization. One LEPO contract usually equals 1,000 shares. The exercise price for a LEPO is usually one cent per share or $10 per contract. The premium that an investor pays for investing in a LEPO is not paid upfront upon purchase of the option. Instead, margins are paid during the life of the LEPO and the LEPO holder pays the balance of the premium if and when the investor exercises the LEPO. Because a LEPO exercise price is so deep-in-the-money, purchasing a LEPO gives a LEPO investor similar exposure to a stock purchase.

LEPOs would not be suitable, however, for investors seeking to invest in assets with less risk than stocks. For example, a LEPO would not be a suitable alternative investment to a cash investment with potential risks and returns comparable to a cash investment because purchasing a LEPO gives an investor similar exposure to a stock purchase. Stocks are generally considered to expose an investor to greater potential risk than cash investments. And the Swiss Options Exchange and Australian Stock Exchange have not offered LEPOs based on currencies, therefore LEPOs also would not be a suitable investment for investors seeking to manage currency risk.

Foreign exchange products, such as currency warrants, exchange traded foreign exchange options, foreign exchange forward transactions, foreign exchange futures, and foreign exchange spot transactions, can be attractive to investors seeking to have investment appreciation treated as capital gains. But historically, investors have not generally considered foreign exchange products to be attractive alternatives to cash investments. Investors have generally considered foreign exchange products to pose greater potential risks than cash investments. But cash investments cannot be used to manage currency risk. And cash investments generally produce interest income as opposed to capital gains.

In the late 1980s, some corporations may have written currency options with high upfront premiums and low exercise prices, which were structured as a call on cash in one currency and a put on cash in a second currency. Those options (to the extent that they were actually written) were private transactions between corporations and financial institutions (i.e., institutions that collect funds from the public and place them in financial assets as opposed to tangible property) in which the corporations wrote the options to the financial institutions for purposes of obtaining financing. The underlying assets of those options (to the extent that they were actually written) were limited to cash and were structured as a call on cash in one currency in cash and a put in cash in a second currency. They did not use cash investments, such as money market funds, as the asset for the call. And they did not use cash investments and other market-traded financial assets as the asset for the put.

Those options (to the extent that they were actually written) also were not written for investment purposes (i.e., for purposes of obtaining more money through the investment of existing money). They were written to obtain financing. The corporations were in essence borrowing cash in one currency from the financial institutions and were obligated to pay the financial institution back with cash in a second currency at a specified expiration date for the currency option. The options that they may have written were economically equivalent to a loan.

And they also were not marketable securities that were traded on an exchange or over-the-counter. An exchange is a market in which assets, such as stock, options, bonds, and commodities, are traded, such as the Swiss Exchange or the New York Stock Exchange. An over-the-counter security is one that is not traded on an exchange. Over-the-counter securities are traded over a decentralized market where geographically dispersed brokers and dealers are linked through telephones, computers and other methods of voice and data communication.

Those options (to the extent they were actually written) also were not liquid securities that the banks that easily could be converted into cash by selling the options (before they expired) to other purchasers in a secondary market for the options. A secondary market is a market in which an option can be traded after it is first initially offered in a primary market.

The currency options that corporations may have written to financial institutions in the late 1980s also would not necessarily have been suitable for investors seeking an alternative to a cash investment or for investors seeking to invest in a foreign exchange product for speculation or risk hedging. Investors seeking an alternative to a cash investment or to a foreign exchange option for speculation or risk hedging would prefer the investment to be a marketable security that is traded in a liquid market that allows for buying and selling at relatively low transaction costs.

In addition, to the extent that financial institutions may have purchased deep-in-the-money currency options in the late 1980s from client corporations seeking financing, the financial institutions would have been exposed to counterparty risk (i.e., the risk to the option buyer that the option writer will not sell the underlying asset as agreed). In other words, the financial institution would have been exposed to the risk that the corporation would have defaulted on its obligation to pay the bank back upon exercise of the option that the corporation issued to the financial institution. In order to properly hedge against that counterparty risk, financial institutions would have to require margins or credit lines from the client corporation issuer. To the extent that financial institutions ever did purchase these options from their clients, they have discontinued that practice.

It is desirable to make available to investors a currency option for investment purposes that can be used for speculative currency trading, currency risk management or risk hedging, or as an alternative to a cash investment and which produces returns that are capital gains as opposed to interest income. It is also desirable to have that currency option be a marketable security that is capable of being traded over electronic banking systems, inter-bank markets, the internet, exchanges, over-the-counter, or other communication channels; combine advantageous characteristics of foreign exchange products (such as currency options and foreign exchange forward transactions) and cash investments; and not expose the option writer to counterparty risk or require credit margins or credit lines.

### SUMMARY OF THE INVENTION

The present invention is directed to overcoming the disadvantages of prior art investment assets to make available to investors an inventive currency option that can be used for investment purposes for speculative currency trading, currency risk management or risk hedging, or an alternative to a cash investment. The inventive currency option produces returns that are capital gains as opposed to interest income. It is a marketable security that can be traded over electronic banking systems, inter-bank markets, the internet, exchanges, over-the-counter, or other communication channels; it combines advantageous characteristics of foreign exchange products (such as currency options and foreign exchange forward transactions) and cash investments with the trading and distribution capabilities of a marketable security; and it does not expose the option writer to counterparty risk or require margins or credit lines.

The present invention is directed to a method and system for offering and selling an inventive currency option that is a marketable security. The currency option is a call on a first asset in a first currency and a put on a second asset in a second currency. In an exemplary embodiment, the currency option is a warrant.

In one embodiment, the method involves exchanging a first asset in a first currency for a second asset in a second currency at an exchange rate; determining an option price for the currency option using the exchange rate, inter-bank interest rate, and known option pricing methods; and purchasing the currency option with the second asset in a second currency. The currency option has an issue date, an expiration date, and an exercise price. The currency option is a call on the first asset in the first currency and a put on the second asset in a second currency. The currency option is a marketable security; is highly deep-in-the-money; has a very low exercise price; and has an option price that reflects a high upfront premium. The first asset can be cash or a cash investment, and the second asset can be any marketable financial instrument.

In another embodiment, the method involves determining an option price for the currency option and exchanging a second asset in a second currency for the currency option. The currency option is a call on a first asset in the first currency and a put on the second asset in the second currency. The currency option has an issue date, an expiration date, and an exercise price. The currency option is a marketable security; is highly deep-in-the-money; has a very low exercise price; and has an option price that reflects a high upfront premium. The first asset can be cash or a cash investment, and the second asset can be any marketable financial instrument.

As an aspect of the present invention, a computer-implemented system may perform some or all of the steps in the inventive method.

It is an object of the invention to overcome deficiencies in the prior art by providing a method for offering and selling an ambivalent currency option that is either quasi-risk-free or exposed to currency risk, which combines advantageous characteristics of foreign exchange products (such as currency options and foreign exchange forward transactions) and cash investments with the trading and distribution capabilities of a marketable security.

The invention has the advantage of being an unleveraged and securitized alternative to existing foreign exchange products.

The invention also has the advantage of offering investors an alternative to existing cash investments that produces investment appreciation (or depreciation) that takes the form of a capital gain (or capital loss) as opposed to ordinary income and also permits investors to manage currency risk.

An additional advantage of the invention is that, depending upon the investor's reference currency, the inventive currency option can be quasi-risk-free and suitable as an alternative to a cash investment, or it can be risky and suitable for currency risk management, risk hedging, or speculative currency trading.

Another advantage of the invention is that the currency option of the invention is a marketable security that is liquid and can be traded with relatively low transaction costs.

The option writer will not have any counterparty risk and will not need to obtain any margin or credit line from the purchaser to issue the inventive currency option. Yet another advantage of the invention is that when the issuer of the option is a financial institution as opposed to a client of a financial institution, the counterparty risk to the purchaser should not be appreciably greater than it would be if the purchaser invested in a cash investment with the financial institutions.

These objects and advantages of the invention described above are illustrative and not exhaustive. The foregoing advantages and other advantages will become more apparent from the accompanying drawings and following detailed description.

### BRIEF DESCRIPTION OF THE DRAWINGS

The following detailed description, which is given by way of example that is not intended to limit the present invention, will be best understood in conjunction with the accompanying drawings in which:

FIG. 1 is a flow chart that illustrates one embodiment of the method of the present invention for offering and selling the inventive currency option of the invention;

FIG. 2 is an example of terms that would be included on a term sheet for the inventive currency option of the invention;

FIG. 3 is a cash flow profile for an example of the currency option of the invention using the terms of the term sheet of FIG. 2;

FIG. 4 is a flow chart that demonstrates how one embodiment of the method of the present invention for offering and selling an inventive currency option would be applied;

FIG. 5 illustrates another embodiment of the method of the present invention for offering and selling an inventive currency option; and

FIG. 6 schematically illustrates a computer-implemented system used to carry out the method of the present invention for offering and selling an inventive currency option.

### DETAILED DESCRIPTION OF THE INVENTION

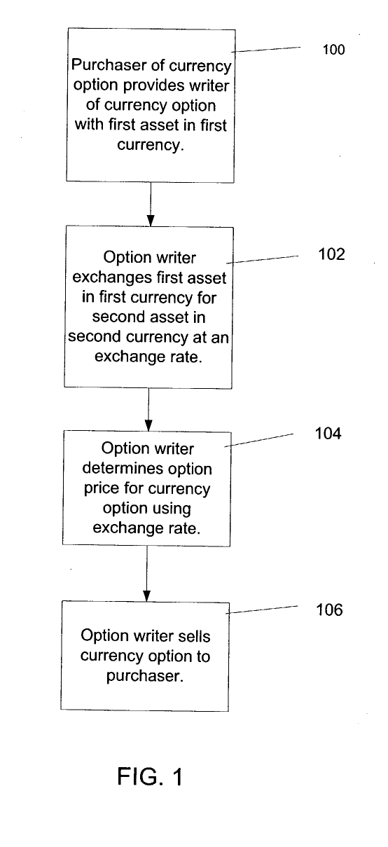

FIG. 1 is a flow chart that demonstrates one embodiment of a method for offering and selling the inventive currency option. It should be understood that FIG. 1 is exemplary. The steps of FIG. 1 do not have to be performed in any particular order and can be performed in a different order or simultaneously.

In step 100, the purchaser of the currency option provides the writer of the currency option with a first asset in a first currency. In an exemplary embodiment, the first asset would be cash. But the first asset could be any cash investment, such as a bond, Treasury bill, note, debenture, or commercial paper.

In step 102, the option writer exchanges the first asset in a first currency for a second asset in a second currency at an exchange rate. This transaction is a spot transaction. In an exemplary embodiment, the second asset would be cash. The second asset, however, also could be any asset (in particular, any asset that is traded over financial markets). For example, the first asset could be a currency and the second asset an exchange-traded commodity asset. The option could be structured as call USD/put Copper with an exercise price of a nominal fraction of units of Copper per one USD.

The first and second currencies could be any currencies. In an exemplary embodiment, the first and second currencies could be chosen from the major currency pairs of the United States Dollar (USD), Euro (EUR), Swiss Franc (CHF), United Kingdom Pound (GBP), and Japanese Yen (JPY).

In step 104, the writer of the option determines the option price for the currency option. The option price can be determined using methods that are well-known in the art and which are based on the option pricing method of Black and Scholes. When using option pricing methods based on the method of Black and Scholes, the option price preferably should be determined using the exchange rate that was used for the spot transaction to exchange the first asset in a first currency for the second asset in the second currency.

The option price also can be determined by valuing cash flows resulting from investing in the option as if those cash flows were certain and not dependent upon the option purchaser's choice to exercise the option.

Whether the option price is determined using option pricing methods or by valuing all cash flows as if they were certain, pricing preferably should be determined based on the inter-bank interest rate, such as the London Interbank Offered Rate (LIBOR). LIBOR is the rate of interest that major international banks in London charge each other for borrowings.

In an exemplary embodiment, the currency option is a call warrant, and the option price of the call warrant would be quoted to the purchaser in terms of the second currency. But the currency option could also be quoted in the first currency.

In step 106, the option writer sells the currency option to the purchaser. The currency option is structured as a call on the first asset in a first currency and put on the second asset in the second currency. For the exemplary embodiment where the currency option is a warrant, there would also be a conversion ratio. The conversion ratio is amount of the first asset in the first currency that the option purchaser would receive per each warrant upon exercise of the option. For example, if the currency option is structured as a call on United States Dollars (USD) and a put on Euros (EUR), one example of a conversion ratio could be that 1 warrant is equal to 100 USD. Thus, when the option is exercised each warrant will be converted to USD at a price of 100 USD per warrant.

The currency option also has an issue date and expiration date. In an exemplary embodiment, the expiration date is one year from the issue date. But the expiration date could be at any time after the issue date.

In one embodiment, the currency option is a European-style option that is exercisable only on the expiration date. If the first asset is a cash investment that increases in value from interest earned on the investment, however, the currency option can be an American-style option that can be exercised at any time before or on the expiration date. The currency option has a very low exercise price that makes the currency option highly deep-in-the-money. As stated, a call option with an exercise price substantially below the underlying asset's market price is deep-in-the-money. Specifically, in the present invention, the exercise price is preferably also highly deep-in-the-money. A highly deep-in-the-money option is an option with an exercise price that is several multiples below the underlying asset's market value. It has a nominal exercise price that is a fraction of the underlying asset's market value. In an exemplary embodiment, the exercise price is equivalent to less than or equal to 10% of the value of the call of the first asset in the first currency on the issue date.

In one embodiment, the currency option also has an option price that reflects a high upfront premium. In other words, the high upfront premium results in the purchaser paying to the issuer the majority of the purchase price of the call upfront upon purchase of the currency option. In an exemplary embodiment, the high upfront premium is equivalent to at least 90% of the value of the call on the first asset in the first currency on the issue date.

The high up-front premium, very low exercise price, and European-style exercise at maturity result in the currency option taking on beneficial characteristics of a forward purchase of the first asset (the call asset) combined with an investment of the second asset (the put asset). Economically, the inventive currency option corresponds to an unleveraged long position in the call currency and a corresponding short position in the put currency. As a result, for an investor whose reference currency (i.e., the currency of the country where the purchaser lives or the currency that investor uses most often) is the call currency, the inventive currency option becomes a quasi-risk-free investment in the investor's reference currency.

The option writer will not have any counterparty risk and will not need any credit margin or credit line from the purchaser. And when the option writer is a financial institution as opposed to a customer of a financial institution, the counterparty risk to the purchaser should not be appreciably greater than it would be if the purchaser invested in a cash investment with the financial institutions.

In the same way that the price of a LEPO moves more or less in parallel to the price of the underlying stock of the LEPO, the inventive currency option of the invention should move more or less in parallel with the exchange rate of the currency pair of the currency option. For an investor whose reference currency (i.e., the currency of the country where the purchaser lives or the currency that investor uses most often) is the call currency, the risks of the currency option are reduced and quasi-risk-free because the investor will be receiving the investor's own reference currency. For other investors, whose reference currency is not the call currency, the currency option will be suitable for risk taking or hedging risk.

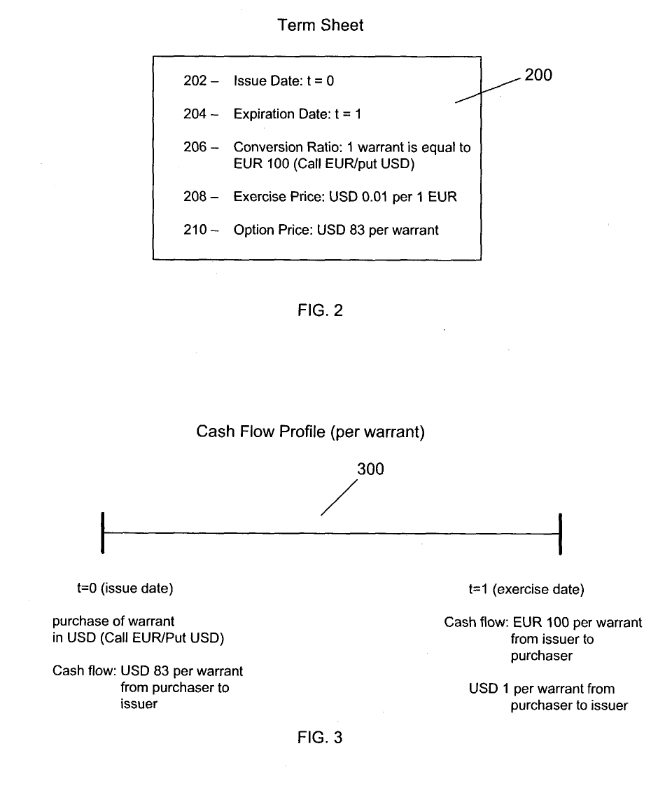

For example, assume that the inventive currency option is offered to a purchaser with the terms reflected in term sheet 200 of FIG. 2. The currency option of term sheet 200 has an issue date 202 of time=0; an expiration date 204 of time=1; a conversion ratio of 1 warrant is equal to EUR 100, where the option is structured as call EUR/put USD; an exercise price 206 of USD 0.01 per 1 EUR; and an option price 210 of USD 83 per warrant.

FIG. 3 is a cash flow profile 300 for a currency option with the terms of term sheet 200 of FIG. 2. At the issue date t=0, the purchaser purchases the warrant at USD 83 per warrant. The cash flow goes from the purchaser of the option to the issuer. At exercise date t=1, the cash flow is EUR 100 per warrant to the purchaser and USD 1 per warrant to the issuer (reflecting the exercise price of USD 0.01 per 1 EUR multiplied by the 100 EUR per warrant).

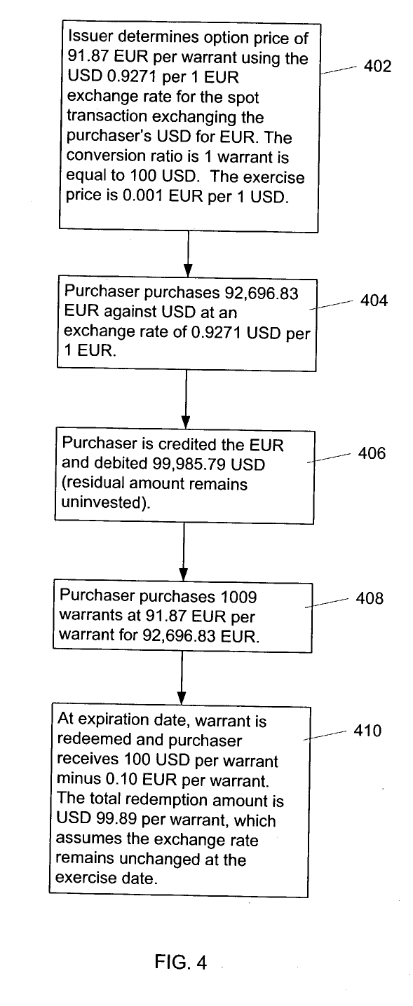

As another example, FIG. 4 is a flow chart demonstrating how the embodiment of the inventive method demonstrated in the flow chart of FIG. 1 can be applied to offer and sell the currency option of the invention to a United States purchaser that wants to invest USD 100,000 in an alternative to a cash investment. The currency option of the invention could be structured as a warrant that is a call on USD and a put on EUR that has an expiration date that is one year from the issue date and an exercise price that is 0.001 EUR per 1 USD.

The purchaser's 100,000 USD are to be exchanged for Euros at a first exchange rate in a spot transaction. Assume for purposes of this example, the exchange rate at the time of the spot transaction was 0.9271 EUR per 1 USD.

In step 402, the issuer of the currency option determines the option price using the same exchange rate to be used for the spot transaction and inter-bank rates, with option pricing methods that are based on the method of Black and Scholes and are well-known in the art, or by pricing it as a forward transaction using methods that are also well-known in the art. Assuming for purposes of this example, the option price, which would typically be increased by an issuer margin, is 91.87 EUR, and the conversion ratio is 1 warrant is equal to 100 USD.

In step 404, the purchaser would purchase 92,696.83 EUR against USD at an exchange rate of 0.9271 EUR per 1 USD. In step 406, the purchaser would be credited the EUR and debited 99,985.79 USD. In step 408, the purchaser's resulting 92,696.83 EUR would be used to purchase 1009 warrants for a total amount of 92,696.83 EUR. The residual USD of the intended investment would not be invested.

In step 410, upon exercise of the warrant at the date of expiration, the purchaser would receive the redemption rate of 100 USD for each warrant minus 0.10 EUR per each warrant (the exercise price of 0.001 EUR per 1 USD) for a total USD 99.89 per warrant (after deduction of an issuer margin and assuming a USD/EUR exchange rate that remains unchanged). The total redemption amount would be USD 100,789.01. Assuming that exchange rates remain unchanged on the expiration date, the yield to maturity of the option corresponds approximately to the inter-bank interest rate underlying the determination of the option price minus a margin paid to the issuer.

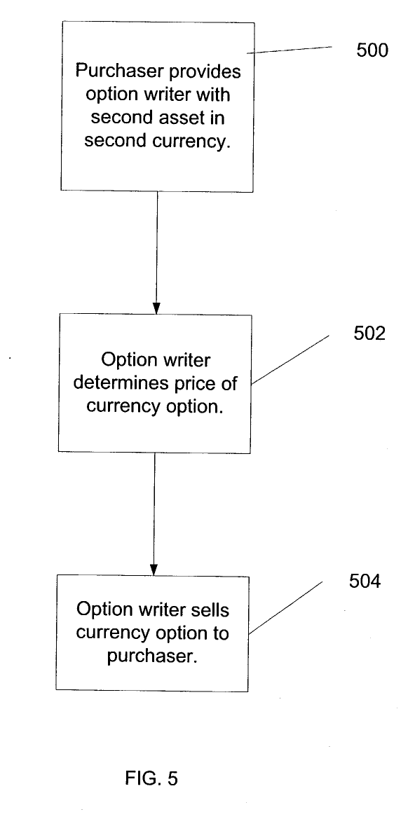

FIG. 5 is a flow chart that illustrates another embodiment of a method for offering and selling the inventive low exercise price currency option. Again, it should be understood that the FIG. 5 is exemplary. The steps of FIG. 5 do not have to be performed in any particular order and can be performed in a different order.

In step 500, the purchaser provides the writer of the option with a second asset in a second currency. In step 502, the writer of the option determines the option price of the currency option. The option price is determined by using methods that are well-known in the art and are based on the option pricing methodology of Black and Scholes or based on methodology for pricing forward transactions.

In step 504, the option writer sells the currency option to the purchaser. The currency option is structured as a call on the first asset in a first currency and put on the second asset in the second currency. In an exemplary embodiment, the currency option is a call warrant, and the option price of the currency option is quoted to the purchaser in terms of the second currency. However, the currency option also could be quoted in the first currency.

The currency option has an issue date and expiration date. For the exemplary embodiment where the currency option is a warrant, there would also be a conversion ratio.

In an exemplary embodiment, the expiration date is one year from the issue date. But the expiration date could be at any time after the issue date. The currency option is a European-style option that is exercisable only on the expiration date. The currency option has a very low, nominal exercise price that makes the currency option highly deep-in-the-money. In an exemplary embodiment, the exercise price is equivalent to less than or equal to 10% of the value of the call in the first asset in the first currency on the issue date.

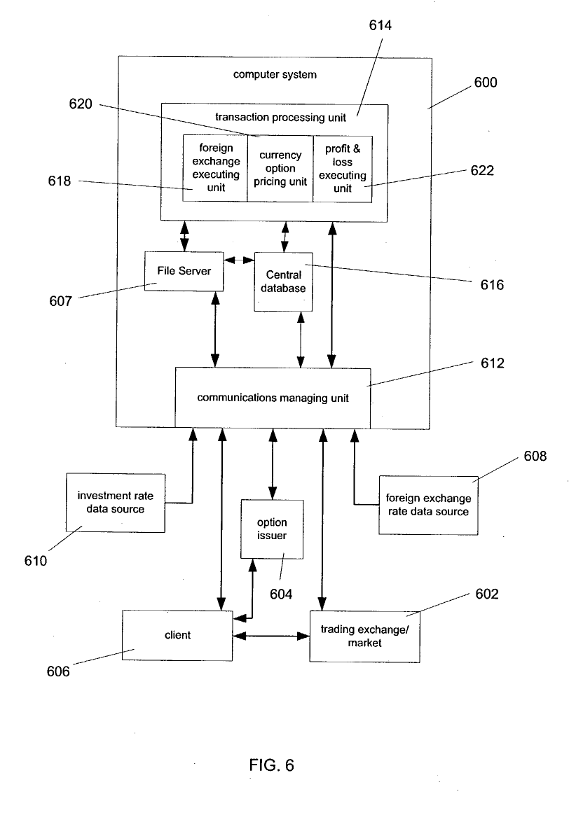

FIG. 6 is an example of the system of the present invention. The system includes a computer system 600. Computer system 600 includes computer readable storage medium having executable instructions and the computer architecture discussed below. An option issuer 604 may offer and trade the currency option with a client 606 in several ways.

For example, in communication with the computer system 600 are exchanges 602 on which the currency option may be traded, such as the Swiss Exchange. The currency option may also be offered from the issuer 604 or traded directly between the issuer 604 and the client 606. The currency option may be offered on the option issuer's website, or the website of a financial network, such as Bloomberg Financial or Reuters.

In an exemplary embodiment, detailed information regarding the currency options is transmitted and provided electronically. For example, computer system 600 may include a file server 607 containing electronically displayable files provided to a website for consideration by client 606 or directly to client 606 or the client's agent by, for example, electronic mail. In an exemplary embodiment, the files include a term sheet containing the terms and conditions of the currency option including the currency pair (the first currency and second currency), the assets (the first asset and the second asset), that the currency option is a call on the first asset in the first currency and a put on the second asset on the second asset in the second currency, the expiration date, the option price, and the exercise price.

Client 606 may utilize conventional electronic banking systems to purchase the currency option from issuer 604 or it may use some other form of communication, such as telephone or facsimile, to communicate the client's desire to purchase the certificate from the issuer or a broker. In an exemplary embodiment, the issuer 604 has one or more terminals, each of which include a display screen, data input devices, such as a keyboard and mouse, and which are connected to output devices, such as a printer for printing various reports. Likewise, in an exemplary embodiment, the client 606 has one or more terminals, each of which also include a display screen, data input devices, such as a keyboard and mouse, and which are connected to output devices, such as a printer for printing various reports.

The computer readable storage medium and computer architecture of computer system 600 may reside on a single computer terminal or workstation or, in an exemplary embodiment, reside on a remote server of a network to which the terminals of the issuer 604 are connected as shown in FIG. 6. For example, the network may be a local area network dedicated to a single office of an enterprise or a wide area network serving various offices of one or more enterprises.

Computer system 600 is also connected via a communication link to an external foreign exchange rate data source 608 for providing the computer system 600 with real-time exchange rate data, such as the spot rates used in the transactions described herein. Foreign exchange rate data source 608 may be any source of rates suitable for spot and other foreign exchange related rates. Also, exchange rate data source 608 may be a different source depending on the type of rate desired. For example, the spot rates could be the spot rates published on Reuters.

The various communications links between market 602, client 606, foreign exchange rate data source 608, and computer system 600, including issuer 604, can be established over any data communications network capable of effectively transmitting the data, such as a worldwide interconnected network of computers (e.g., the Internet), a public switch telephone network, or any other suitable data communication pathway. Also, the information/data may be transmitted using a variety of data communication paths such as phone lines, wireless transmissions and/or digital data lines.

Computer system 600 also includes a communications managing unit/system 612 for managing communications and interactions between computer system 600, market 602, client 606 terminals, and foreign exchange rate data source 608. The communications managing unit 612 includes a client interface through which the client information is output and received.

Computer system 600 also includes a transaction processing unit 614 for executing the various underlying transactions of the currency option as discussed herein. Transaction processing unit 614 communicates with the foreign exchange rate data source 608 via the communications managing unit 612.

Computer system 600 also includes a central database for storing all information of all transactions relating to each traded currency option. In an exemplary embodiment, central database 616 receives information from, and may be accessed by, all the components of computer system 600. The information stored in central database 616 may include, for example the terms and conditions of the currency option including the currency pair (the first currency and second currency), the assets (the first asset and the second asset), that the currency option is a call on the first asset in the first currency and a put on the second asset on the second asset in the second currency, the expiration date, the option price, and the exercise price.

The client 606 may be any individual, group or institution that wishes to trade the currency option of the present invention. For example, the client could be an individual investor, a financial institution, such as a bank acting as an agent for its own clients, or any other entity, such as a corporation or association, or a broker acting on behalf of any of these individuals or entities.

Transaction processing unit 614 includes software, including suitable application software, residing in a computer readable storage medium in the form of encoded executable instructions for operating computer system 600 and processing the underlying transactions associated with the currency option of the invention.

Specifically, transaction processing unit 614 at least includes a foreign exchange executing unit 618 for executing the underlying transactions relating to the offering and selling the currency option. For example, foreign exchange executing unit 618 exchanges the client's first asset in a first currency for a second asset in a second currency by conducting a spot transaction according to one embodiment of the method of the current invention. Currency option pricing unit 620 calculates the option price of the currency option using the exchange rate. Transaction processing unit 614 further includes a profit and loss executing unit 622 which functions to calculate any profits or losses in the underlying transactions.

The present system can utilize various devices, such as personal computers, servers, workstations, PDA's, and the like. For example, the client terminal can be a handheld device such as a mobile phone or a PDA. Various channels for communication can be used. Further, the various functions can be integrated in one device. The disclosed functional units, such as foreign exchange swap executing unit 618 and profit and loss executing unit 622, for example, are segregated by function for clarity. The various functions can be combined or segregated as hardware and/or software modules in any manner. The various functions can be used separately or in combination.

Finally, it should be understood that the foregoing description is merely illustrative of the invention. Numerous alternative embodiments within the scope of the appended claims will be apparent to those of ordinary skill in the art.

What is claimed is:

1. A method for offering and selling a currency option comprising:
an option issuer determining an option price for the currency option; and
selling the currency option to a purchaser, wherein the currency option has an option price, an issue date, an expiration date, and an exercise price,
wherein the currency option is a call on a first asset in the first currency and a put on a second asset in the second currency,
wherein the option issuer is a financial institution,
wherein the purchaser has purchased the currency option for investment purposes,
wherein the currency option is a marketable security, and
wherein the currency option is highly deep-in-the-money.

2. The method of claim 1, wherein the exercise price of the highly deep-in-the-money currency option is equivalent to less than or equal to substantially 10% of the call on the first asset in the first currency valued on the issue date.

3. The method of claim 1, wherein the option price reflects a high upfront premium, said high upfront premium is equivalent to at least substantially 90% of the call on the first asset in the first currency valued on the issue date.

4. The method of claim 1, wherein the currency option is exercisable only on the expiration date.

5. The method of claim 1, wherein the first asset is a cash investment and the currency option can be exercised at any time before or on the expiration date.

6. The method of claim 1, wherein the exercise price is nominal.

7. The method of claim 1, wherein the expiration date occurs within two years from the issue date.

8. The method of claim 1, wherein the first asset is a cash investment.

9. The method of claim 1, wherein the currency option is a warrant and has a conversion ratio.

10. The method of claim 1, wherein the first and second currencies are selected from the group consisting of the United States Dollar (USD), Euro (EUR), Swiss Franc (CHF), United Kingdom Pound (GBP), and Japanese Yen (JPY).

11. The method of claim 1, wherein the currency option exposes the purchaser to potential risk and potential return similar to potential risk and potential return of a cash investment or forward transaction.

12. A method for offering and selling a currency option comprising:
exchanging a first asset in a first currency for a second asset in a second currency at an exchange rate;
an option issuer determining an option price in the second currency for the currency option using the exchange rate; and
selling the currency option to a purchaser who is purchasing the currency option for investment purposes, wherein the currency option has an issue date, an expiration date, and an exercise price,
wherein the currency option is a call on the first asset in the first currency and a put on the second asset,
wherein the option issuer is a financial institution,
wherein the currency option is a marketable security, and
wherein the currency option is highly deep-in-the-money.

13. The method of claim 12, wherein the exercise price of the highly deep-in-the-money currency option is less than or equal to 10% of the call on the first asset in the first currency valued on the issue date.

14. The method of claim 12, wherein the option price reflects a high upfront premium, said high upfront premium is equivalent to at least substantially 90% of the call on the first asset in the first currency valued on the issue date.

15. The method of claim 12, wherein the first asset is a cash investment and the currency option can be exercised at any time before or on the expiration date.

16. The method of claim 12, wherein the exercise price is nominal.

17. The method of claim 12, wherein the expiration date occurs within two years from the issue date.

18. The method of claim 12, wherein the currency option can be exercised only at the expiration date.

19. The method of claim 12, wherein the first asset is a cash investment.

20. The method of claim 12, wherein the currency option is a warrant and has a conversion ratio.

21. The method of claim 12, wherein the first and currencies are selected from the group consisting of the United States Dollar (USD), Euro (EUR), Swiss Franc (CHF), United Kingdom Pound (GBP), and Japanese Yen (JPY).

22. The method of claim 12, wherein the currency option exposes the purchaser to potential risk and potential return similar to potential risk and potential return of a cash investment or forward transaction.

23. A currency option comprising:
a call on a first asset in a first currency;
a put on a second asset in a second currency;
an option price;
an issue date;
an expiration date; and
an exercise price,
wherein the currency option is a marketable security,
wherein the currency option is issued by a financial institution for investment purposes,
wherein the currency option is highly deep-in-the-money, and
wherein the exercise price is nominal.

24. A method for a financial institution to offer and sell to a purchaser a marketable security exposing the purchaser to potential risk and potential return similar to potential risk and potential return of a cash investment or forward transaction comprising:
selling to the purchaser the marketable security for investment purposes,
wherein the marketable security is an option to buy a fixed amount of a first asset in a first currency that has an option price based on a second currency, and
wherein the option has a nominal exercise price expressed in terms of a second asset in the second currency, an issue date, and an exercise date, and
wherein the marketable security is highly deep-in-the-money.

25. A storage medium comprising:
information related to the purchase and sale of a currency option, said information including:
that the currency option is a call on a first asset in a first currency,
is a put on a second asset in a second currency,
has an issue price,
has an issue date,
has an expiration date, and
has an exercise price,
wherein the currency option is issued by a financial institution for investment purposes,
wherein the currency option is highly deep-in-the-money,
wherein the currency option is a marketable security, and
wherein the exercise price is nominal.

26. A storage medium having instructions for offering and purchasing a currency option, the medium comprising:
instructions for determining an option price for the currency option; and
instructions for selling the currency option to a purchaser,
wherein the currency option is a call on a first asset in a first currency and a put on a second asset in a second currency,
wherein the option has an issue date, expiration date, and exercise price,
wherein the currency option is a marketable security,
wherein the currency option is issued by a financial institution for investment purposes,
wherein the currency option is highly deep-in-the-money, and
wherein the exercise price is nominal.

27. A computer-implemented system for offering and selling a currency option, comprising:
a communications managing unit and a transaction processing unit,
wherein the communications managing unit manages communications relating to offering and selling the currency option,
wherein the transaction processing unit processes transactions in the currency option, the currency option comprising
a call on a first asset in a first currency,
a put on a second asset in a second currency,
an issue price,
an issue date,
an expiration date, and
an exercise price,
wherein the currency option is a marketable security,
wherein the currency option is highly deep-in-the-money, and
wherein the exercise price is nominal.
